(19) United States
(12) Patent Application Publication
(10) Pub. No.: US 2025/0062925 A1
(43) Pub. Date: Feb. 20, 2025

(54) PoE Switch for Connecting External Devices

(71) Applicant: Smart Resource Creations LLC, Wilmingtion, DE (US)

(72) Inventors: Jelani Gregory McCoy, Wilmington, DE (US); Kenja Palmer, Bear, DE (US); Peter Matthew Newman, San Diego, CA (US); Shawn Levin Carn, Claymont, DE (US); Lyle Aaron Street, Wilmington, DE (US)

(73) Assignee: Smart Resource Creations LLC, Wilmingtion, DE (US)

(21) Appl. No.: 18/807,471

(22) Filed: Aug. 16, 2024

Related U.S. Application Data
(60) Provisional application No. 63/520,436, filed on Aug. 18, 2023.

(51) Int. Cl. H04L 12/10; H04L 12/40

(52) U.S. Cl. CPC H04L 12/10; H04L 12/40045

(57) ABSTRACT

A versatile Power over Ethernet (POE) Powered switch designed to connect singular or multiple external PoE-powered devices within a network. This POE switch is physically able to accommodate various shapes and configurations of PoE devices, which can be mounted thereon, providing flexibility in deployment. It serves as a centralized point for distributing data and power, simplifying network setup and reducing installation costs. Users have the option to mount PoE-powered devices directly to or withino it or utilize it without mounting any devices. This design enhances network efficiency, minimizes cable clutter, and offers scalable solutions for diverse applications, including surveillance systems, IoT devices, and smart infrastructure. The POE switch also incorporates wireless ICs, other integrated circuits, and other electronics to provide wireless networking, remote diagnostics, artificial intelligence of things (AIoT), and other varying capabilities.

### CROSS-REFERENCE TO RELATED APPLICATIONS

The present invention claims priority to U.S. Provisional Application Ser. No. 63/520,436, filed Aug. 18, 2023, the entirety of which is hereby incorporated by reference.

### BACKGROUND OF THE INVENTION

FIG. 1 illustrates a top-down floor plan 7 of a surveillance system installation using IP cameras prior to the invention. In a typical prior art installation, each camera (shown as a dot 1) is wired/cabled and the like via ethernet cable (Cat5, Cat6 cable/wire or, Cat7, etc., as is known) directly to a primary Power Over Ethernet (POE) Network Switch 2. The POE switch 2 is also connected to a Network Video Recorder (NVR 3). As part of the network created by the switch and NVR, each camera receives and is identified by a unique internet protocol (IP) address. The cameras 1 also receive power from the POE switch(es) 2. The NVR, which acts as the centralized hub of the system, exchanges data with the cameras via the POE Switch 2 using the camera's IP address. Some NVRs have integrated PoE switches 2, making the NVR with PoE integrated the primary POE switch, labeled 4, eliminating the need for a separate POE switch 2. Thus, POE switch 2 and NVR 3 may be integrated into NVR 4.

As shown in FIG. 1, each camera requires a “homerun” (a direct network, Cat5, Cat6, Cat7, cable/wire) to the primary switch 2. Due to the need for homeruns, installations tend to take a long time and sometimes require creative solutions to manage the number of Cat5, Cat6, Cat7 cable/wire required. Some systems with a high number of cameras require special racks, raceways, and conduits, etc., which adds significantly to the final cost of the project. This is the same process for other PoE powered external devices. They require a “homerun” to a primary POE switch 2.

In a multilevel building 08 of the prior art, shown in FIG. 2 at 8, cameras 1 are often connected to PoE network switches 2 on different floors. The PoE network switches on each floor are then connected to one another via a single ethernet (Cat 5, Cat6, Cat7, etc) cable/wire and ultimately all floor PoE network switches are connected to the primary POE Switch 2, and NVR 3, or a NVR hub with integrated POE switch 4 to create a multi-floor system. The reason for this configuration is to unite the Network with the NVR hub 4 via the primary switch whether integrated into the NVR or as a stand-alone device. In addition, the standard maximum length for a Cat 5, Cat6, Cat7 wire/cable to carry both data and power (PoE) is 100 meters. Beyond this distance, one is likely to encounter issues with power delivery and data transmission quality. In larger CCTV installations numerous switches 2 are often required. In larger PoE powered external device installations that might include cameras, access points, sensors and so on numerous switches 2 are also often required.

### SUMMARY OF THE INVENTION

The present invention is, broadly, a PoE Powered Switch/injector for Connecting External Powered-over-ethernet (“POE” herein) devices to ethernet or other POE devices. Additionally, the POE switch/injector of the present invention may be physically configured to mount with or mate with any other POE or IP (internet protocol) device, such as cameras, sensors, etc., The application relates to the technical field of network devices, particularly power over ethernet, in particular to a PoE powered device and a PoE system.

A primary POE switch as described herein can also mean a POE Injector that connects to a first external device or other device.

The present invention is a multi-shaped, multi configured smart junction box (J-box or “SJB/Hub”) camera (or other) mount Power over Ethernet (POE) powered switch. It may use an artificial intelligence of things (AIoT) hub (HUB), or more technically a single line surveillance camera mount (SLSCM) device that through a Managed or Unmanaged Process connects one or more PoE powered devices and at least one device can mount to the Managed or Unmanaged SJB/HUB, but no device has to mount to the Managed or Unmanaged SJB/HUB.

The purpose of the Single Line Surveillance Camera Mount SLSCM is to dramatically simplify the process currently used to install CCTV systems, as well as other external PoE powered devices. At least one specification heading is required. Please delete this heading section if it is not applicable to your application. For more information regarding the headings of the specification, please see MPEP 608.01(a).

### BRIEF DESCRIPTION OF DRAWINGS

FIG. 1 is a top-down floor plan of a surveillance system of the prior art.

FIG. 2 is a side view of a multilevel surveillance system of the prior art.

FIG. 3 shows one aspect of PoE devices connected using the invention.

FIG. 4 is a top-down view of a surveillance system according to the present invention.

FIG. 5 shows one physical view of the JBox/JBox Hub.

FIG. 6 shows one example of a top and side view of the JBox cover.

FIG. 7 shows one example of the internal layout of the JBox/JBox Hub.

FIG. 8 shows another example of the internal layout of the JBox.

FIG. 9 shows examples of devices that may be used in the present invention.

FIG. 10 shows one embodiment of devices connected according to the invention.

### DETAILED DESCRIPTION OF THE INVENTION

The concept behind the SLSCM SJB HUB (The Camera Box, or “smart” J-Box POE powered HUB or simply “HUB” or “JBox” or “JBox Hub” or “SLSCM” is shown in FIGS. 3 and 6-8. With reference to FIG. 3, a number of JBox devices 5A, 5B, 5C etc. to 5N are shown as a circle with a triangle inside, may be directly connected to each other. Each JBox has within it a PoE ethernet switch and/or a PoE ethernet switch and power injector. Each JBox has mounted thereon a PoE IP camera or other PoE sensor (or simply is used as a POE switch or injector without a sensor or camera). Each JBox 5 receives power from the preceding JBox 5 to power its own devices if possible. If there is insufficient power from a preceding device to power a JBox and its Camera/Sensors, the JBox 5 contains an injector or power source to power itself and/or other subsequent devices. Thus, when designing the system, one can compute power consumption of each JBox with its associated device, if any, and lay the system out with JBox switches and injectors as necessary to power and communicate over PoE with downstream devices.

For Example, if NVR/POE switch 4 can output 30 watts per port, and JBox 5A contains a 5 W camera and 20 W POE switch (that itself provides 15 W PoE), it will be successfully powered by NVR/POE switch 4, and it will output via Ethernet 20 W PoE to the next Jbox 5B.

If 5B, for example, contains a 5 W camera and 10 W POE switch, outputting 5 W PoE, 5B will be successfully powered by the 20 watts from 5A, and will communicate data and low power (5 watts) to 5C.

If JBox 5C contains a 5 W camera it should also contain therein a POE injector and PoE switch that is powered from typical AC (wall output) or DC (specialized battery or other power source). The POE injector will supply newly generated power, which may be 30 Watts or more (if PoE+ or PoE++ is utilized) to downstream products.

By knowing the power consumption of each JBox 5, as well as its capabilities to forward or generate PoE power, a designer can lay out a system where each JBox powers the next, and when power becomes low, POE injectors (which are commonly available and commonly integrated with switches but which integration is not required) are used inside the JBox to create PoE power where necessary. In this manner very long PoE runs are possible without “home runs” used in the prior art. Such power consumption calculations can be managed via a software application, or determined via an unmanaged method. If calculated via a managed method, power and/or data can be controlled and optimized.

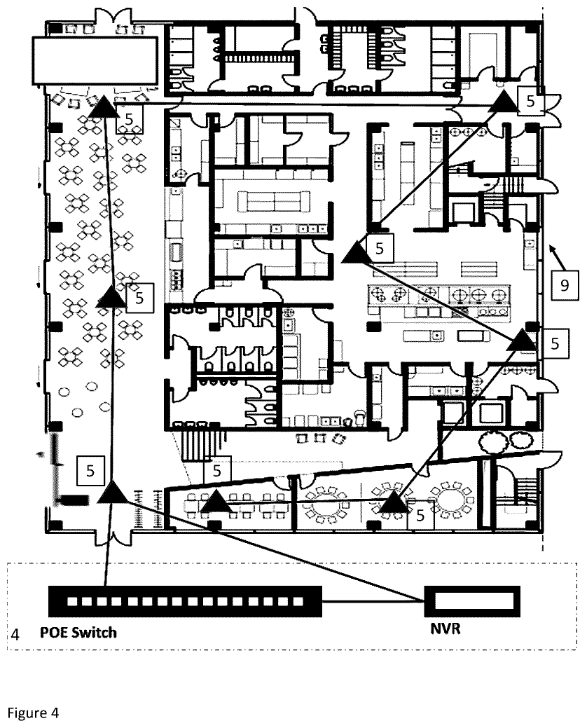

As a result, a single Cat5, Cat6, Cat7 cable/wire can now connect one SJB HUB to another SJB HUB without the need for a “homerun” to each camera from the primary switch and so on. An essentially infinite number of SJB HUBs (in the case of cameras up to the number of IP addresses available on the NVR) can now be daisy-chained, star configured, tree configured together, as well as any other smart pattern that minimizes the amount of cabling needed if single line “home runs” were the only solution. This is shown in FIG. 4, which depicts a daisy-chain of a number of cameras on SJBoxes 5, each of which is connected via a single ethernet cable (shielded twisted pair STP cable) to the primary POE Switch/NVR 4. Once connected to the primary POE switch/NVR 4, the SJB HUB can connect to one or more other SJB HUBs as well as one or more other PoE powered external devices such as an IP camera. The SJB HUB is designed as a stand-alone device that may be installed in every and all locations inside and/or outside any and every Residential, Commercial and industrial and the like locations.

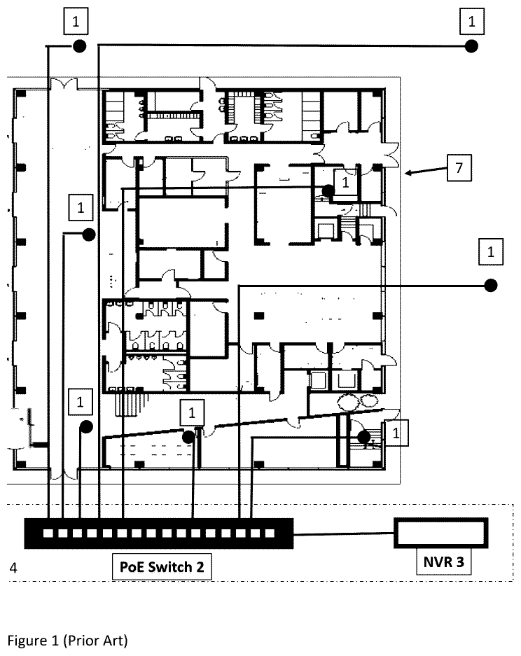

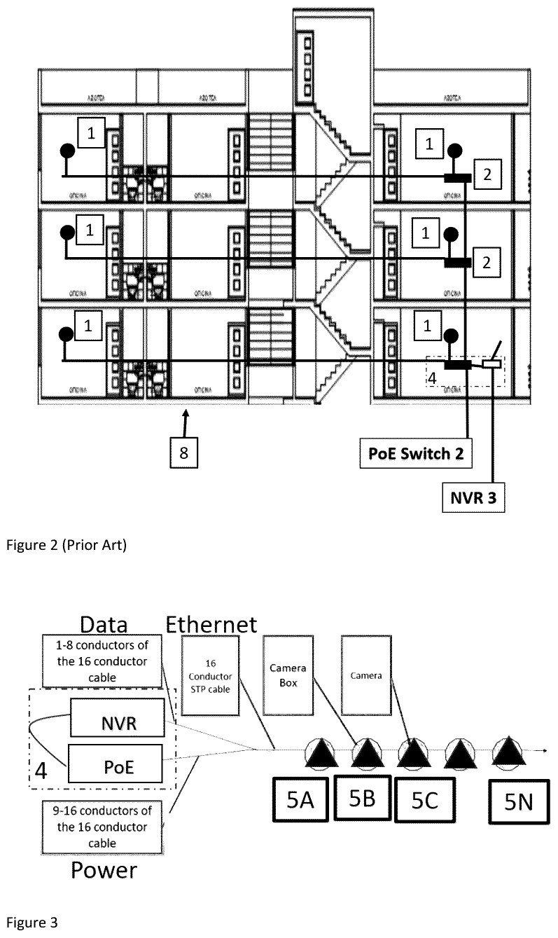

According to the invention, now that each SJB HUB has its own internal switch, optional internal power supply, RJ45 inputs and outputs, the ability to attach cameras, as well as other PoE powered devices, and other novel circuitry, installations can be done without cable/wire “homeruns” back to the primary POE switch. FIG. 4 shows what a similar installation to FIG. 1 would look like using an SJB HUB with attached IP camera (shown as a triangle 5) using a daisy chain pattern connecting the primary PoE switch to the 1st SJB HUB and the 1st SJB HUB to the 2nd SJB HUB and so on and so forth.

Significantly fewer “homerun” connections are needed. Cat5, Cat6, or Cat7 Wire/Cable “homeruns” are only necessary to reach the initial SJB HUB from the initial POE switch. There may be one or more initial “homeruns” from the primary POE switch to the multiple initial SJB HUBs, depending on the installation design configuration, and from there each initial SJB HUB can connect to subsequent SJB HUBs in the chosen design configuration thus also limiting the number of “homeruns” from the primary POE Switch. In the case of a surveillance network installation, each IP camera can mount to the SJB HUB and each SJB HUB runs cabling to reach the next IP camera associated with the next SJB HUB in that string. The design configuration is determined by the installer's assessment of the most efficient and cost-effective way to take advantage of the SJB HUBs. Each SJB HUB can additionally power other PoE powered external devices in the network further limiting the need for “homeruns” from a primary POE switch. This reduces the amount of labor and materials required to complete a project. The invention embodies a green method for installation with fewer material needed, less labor hours, and less energy to install.

Significantly fewer “homerun” connections are needed. Cat5, Cat6, or Cat7 Wire/Cable “homeruns” are only necessary to reach the initial SJB HUB from the initial POE switch. There may be one or more initial “homeruns” from the primary POE switch to the multiple initial SJB HUBs, depending on the installation design configuration, and from there each initial SJB HUB can connect to subsequent SJB HUBs in the chosen design configuration thus also limiting the number of “homeruns” from the primary POE Switch. In the case of a surveillance network installation, each IP camera can mount to the SJB HUB and each SJB HUB runs cabling to reach the next IP camera associated with the next SJB HUB in that string. The design configuration is determined by the installer's assessment of the most efficient and cost-effective way to take advantage of the SJB HUBs. Each SJB HUB can additionally power other PoE powered external devices in the network further limiting the need for “homeruns” from a primary POE switch. This reduces the amount of labor and materials required to complete a project. The invention embodies a green method for installation with fewer material needed, less labor hours, and less energy to install.

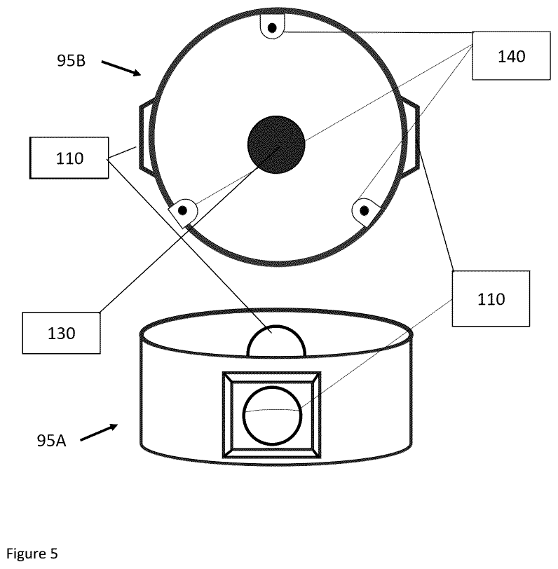

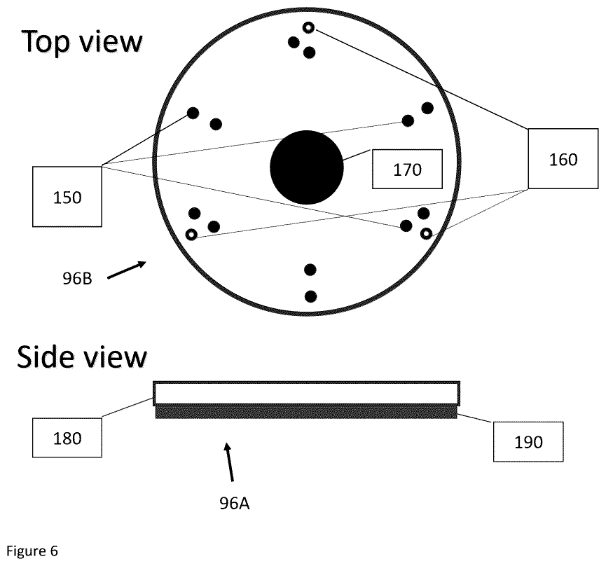

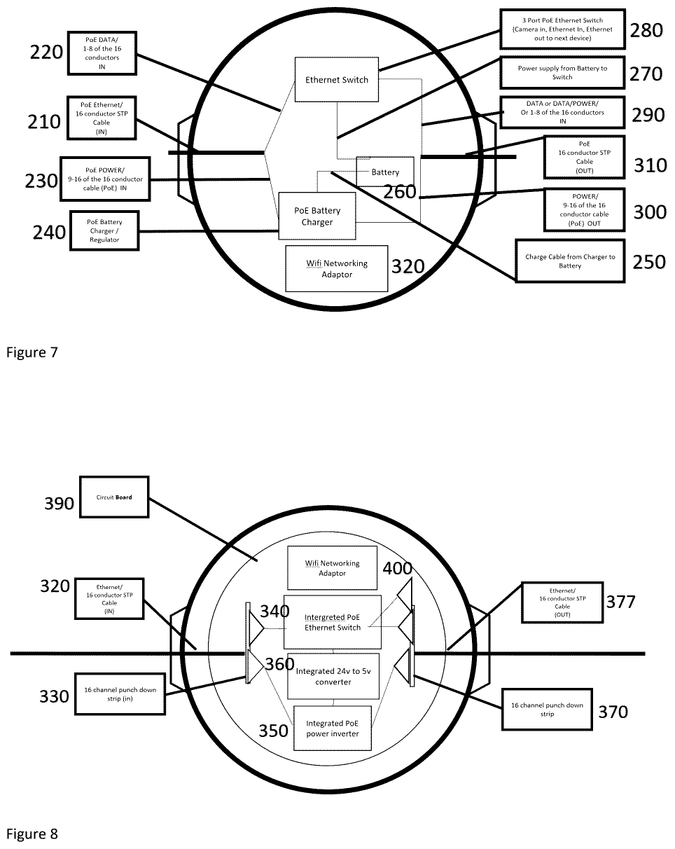

With respect to the camera mount SJB HUB itself, the SLSCM, the camera mount (or camera box), the SJB HUB, may physically take the size and shape of a but not limited to a traditional junction box (“J-box”) that cameras mount to with corresponding camera mounts included, but pursuant to the present invention it contains sophisticated circuitry within, making it a “smart” J-box (SJB) in reality. Such an SJB HUB is shown in FIGS. 5-6 and labeled in FIG. 7. The SJB HUB is not limited to the size and shape of a traditional J-box and as such it is a multi-shaped, multi configured device. Additional imaged configurations could exist.

With respect to FIG. 7, the features of the SJB HUB are shown, including items 220 through 320 as follows. Items 210-230 embody a Cat5, Cat6, or Cat7 cable/wire, etc. as is known, entering the SJB Hub via the PCB and one or more RJ45 jacks, normally with 16 conductors that carries power to and data to and from to the SJB HUB. Item 220 specifically shows that the data conductors (or eight of the conductors (numbers 1-8)) that originate from the primary POE switch go to an internal ethernet switch 280. While the power conductors of the PoE input cable 210 may connect to a “PoE Batter Charger (powered by a battery 260, via 250), it is also possible that the ethernet switch 280 is an integrated switch/injector that has its own AC or DC power source connected to the inlet where cable 210 enters (not shown). Thus, the PoE Battery Charger and battery 260 may be eliminated in certain situations where the POE ethernet switch 280 is also an POE injector, supplying additional power beyond that received at the input 210.

The internal PoE ethernet switch 280 may connect via one port to a PoE camera or other sensor mounted upon the SJB Hub, and may connect to an output port, or two or more, via the PCB and one or more RJ45 jacks at the output 310.

Standard RJ45 ethernet connectors may be provided where wires enter 210 and exit 310. Exit 310 preferably has multiple connectors accessible, and other connectors may be used to connect PoE devices attached to the JBox.

With respect to manufacturing, each of the items 210-320 are currently available or easily adapted by a person of ordinary skill. For example, power over ethernet switches and injectors are common in the industry such as small form 3 port PoE switches. Power inverters and battery chargers for rechargeable batteries are known, especially in the solar industry and can be adapted for use in the networking industry.

The invention integrates the items depicted (including the switches/injectors, battery, the inverter, and other technologies) as a single device that is integrated into the Camera Box SJB HUB, that is sized and shaped in a manner to be able to be installed in existing construction or new construction as the SJB HUB. It is believed that the most common and preferred size of the SJB HUB should at most be approximately 6.5 inches in diameter and 2 inches deep, though many other sizes may be appropriate in certain situations, both larger and smaller but not limited to. The SJB HUB can be shaped as a circle or multi-sided polygon approximating a circle, though many other shapes may be appropriate in differing circumstances according to market requirements and designers' visions.

The SJB HUB can have integrated mounts for any PoE powered external device, such as a suitable camera, and may contain openings or threading that can be used to mount any and all suitable cameras as well as all other PoE powered external devices (PoE Powered Lights, PoE Powered Monitors, PoE Powered TV's, PoE Powered Speakers, PoE Powered Intercom Systems etc.)

The SJB HUB hardware uses a novel approach. FIG. 5 shows a physical drawing of the SJB HUB Base, 95A (side view) and 95B (top View) where item 110 is a three fourths inch raised “knock out” (2 sides and rear-not raised). Also contemplated but now shown is an optional one-half inch reducer Item 120, for thinner cables or if multiple ports are unused. Item 130 is a knockout which can be 3 inches (or more) in diameter, item 140 are mounting points for a camera or multi-position cameras, and could be customized for several other PoE powered external devices. The SJB HUB will include but is not limited to multiple ¾ inch holes with ½ inch reducers and the like etc. Material used for SJB HUBs are but are not limited to metal, plastic, rubber and the like etc.

FIG. 6 shows another embodiment of the Multi Positioned Camera Mount (MPCM) SJB HUB Cover that can mate with the SJB Hub of FIG. 5, as a side view 96A and top view 96B. Here, 150 shows mounting holes (made to fit multiple camera types, as well as several other PoE powered external devices and the like) and the unused holes incorporate rubber stoppers. Item 160 shows holes to mount the MPCM SJB HUB Cover to the SJB HUB Base. Item 170 shows openings for cable/wire pass-through. Item 180 points to the outside diameter which can be any desired measurement. Item 190 is foam weather proofing for outdoor installations. Multi weatherproof cover plates for and not limited to every and any PoE powered external devices and the like with multiple screw patterns. Weatherproof casings will be included in but not limited to each and every SJB HUB to protect Hardware, electronics and the like associated with each and every SJB HUB. FIG. 7 shows the internals of the SJB HUB with items 210 through 320. Here, item 210 is Incoming Cable/wire (from primary POE Switch, or other SJB HUBs), standard PoE/Ethernet cable CAT 5, 6, 7 etc., as is known. It may be a 16 Conductor STP cable for this illustration, 220 being data (pairs numbered with wires 1-8 (data to the internal SJB HUB switch)), and 230 being cable pairs numbered with wires 9-16 (power to internal POE switch and if included the battery charger). Item 240 is the optional Battery Charger-devices are powered by PoE and delivers power to each POE SJB HUB and its battery and/or other power source. Item 250 is a charge cable/wire for the 24v (or 5v or other voltage) delivered to the internal PoE switch, the battery and/or other power source. Item 260 is the battery and/or other power source (Rechargeable, Permanent or Replaceable and the like) with a battery indicator light present inside, on, as well as outside the SJB HUB). Item 270 is the power supply from the battery and/or other power source to the SJB HUB (other PoE Powered external Devices and the like). Item 6 280 is a multi-port POE switch (the SJB HUB with power in and data in and out, including but not limited to USB-C in/out, etc . . . ), item 280 is an incoming and outgoing Cat 5, Cat6, Cat7 cable/wire to and from the primary POE Switch or other SJB HUBs. Item 290 are wire pairs numbered with Cat 5, Cat6, Cat7 cables/wires 1-8 (switch to next SJB HUB), 300 are pairs numbered with Cat 5, Cat6, Cat7 cables/wires 9-16 (PoE Battery Charger to next SJB HUB, 310 is 16 Conductor STP cable. Item 320 is a Wi-Fi Networking Adaptor that will be integrated to enable mesh networking, the implementation of AIoT control, and other communication applications and more.

As described previously, POE switch 280 may also comprise a POE injector with its own inlet power cable and/or with its own power supply, so that 280 may power downstream devices beyond the power from incoming ethernet cable 210. Likewise, the output 310 may contain multiple RJ45 ethernet jacks for multiple PoE cables to multiple devices, both attached and downstream. These jacks normally would be located behind the knock outsknockouts 110 on the output side of the SJB Hub, but can be located anywhere inside or outside of the SJB HUB housing.

FIG. 8 shows a cross section of the box. Here item 320 is an Incoming Cat 5, Cat6, Cat7 Cable/Wire-16 Channel (From primary POE Switch, POE Injectors or prior SJB HUB). Item 330 is a 16 Channel Punch Down Strip (Transfer From STP To Circuit Board). Item 340 is an Integrated POE Switch/POE injector (SJB HUB in, SJB HUB out, data in, data out, USB C in, USB out, etc . . . ). Item 350 is an Integrated PoE Inverter and battery (or other power source) to maintain Charge For PoE Switches/POE injector switches (Rechargeable, Permanent or Replaceable) with a battery and or any other power source indicator light present inside, on, and outside SJB/HUB housing-device Is Powered By PoE And Delivers Power The Integrated Circuit Board. Item 360 is a 24v To 5v Converter (2 Conductors In And Out (PoE, Wifi, Data, IP PoE Devices etc.). Item 370 is a 16 Channel Punch Down Strip (Transfer from Circuit Board To STP). Item 380 is the outgoing Cat5, Cat6, Cat7 Cable/Wire—From internal PoE and punch down strip to external devices or prior SJB HUB. Item 390 is an Integrated Circuit Board holding the other components. Item 400 is a Wi-Fi (USB C in, USB out and the like etc . . . ) Networking Adaptor that can and not limited to enable mesh networking, the implementation of AIoT control, and or other communication applications.

As a person of ordinary skill understands, other features and capabilities can be added to the present invention. For example, WiFi capability, alarm and alert functionality, AIoT Saas, multiple SJB HUB to mount PoE IP Cameras any and all PoE Devices, infrared emitters or other illumination for dark conditions, automatic recording to solid state memory, motion and person detection, etc. There also could be a parallel run of Cat5, Cat6, Cat7, as is known, wiring/cabling between SJBs HUBs for fault tolerance if a single Cat 5, Cat6, Cat7 wire/cable fails.

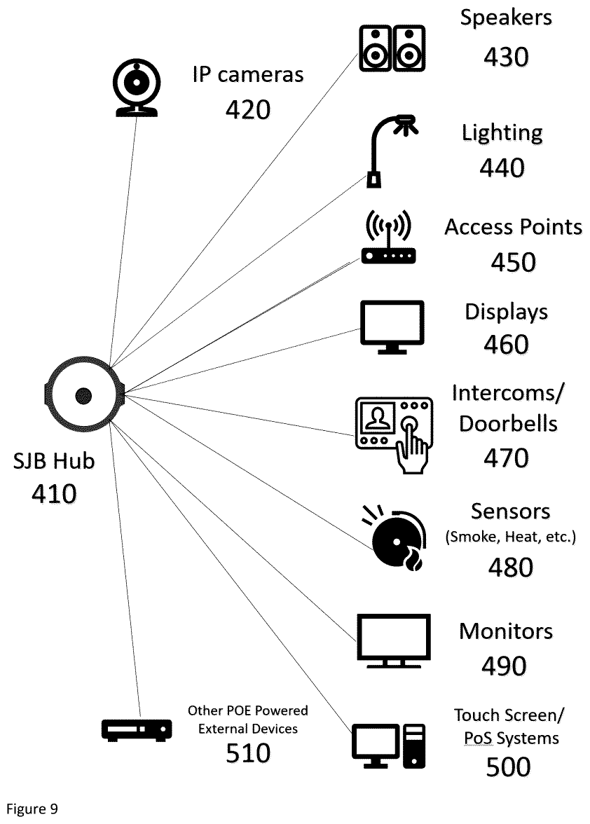

FIG. 9 shows the SJB HUB in a multi-PoE powered external device environment whereas any one device is possible to mount, or no device is needed to mount to it. Item 410 is the SJB HUB. Items 420-500 represent PoE powered external devices available for purchase today. Item 510 represents other PoE powered external devices available today and in the future. As described previously, the SJB Hub may be physically configured to accept mounts for the PoE devices 420-510, either indoors or outdoors.

A test system was developed showing that the concepts here are valid and operational.

The following items were purchased and connected to achieve a working product example:
One (1) Platinum 8-Channel NVR from LTS Security Inc., SKU LTN8708D-P8N,
https://Itsecurityinc.com/, 17333 Freedom Way, City of Industry CA 91748
Six (6) Platinum 4 MP Fixed Turret IP Camera form LTS, SKU LTCMIP3C42WI-28MDA, https://Itsecurityinc.com/, 17333 Freedom Way, City of Industry CA 91748
Three (3) Junction Box-White from LTS, SKU LTB03-W, https://Itsecurityinc.com/, 17333 Freedom Way, City of Industry CA 91748
Three (3) Wire Intake with Junction Box from LTS, SKU LTB307, https://Itsecurityinc.com/, 17333 Freedom Way, City of Industry CA 91748
One thousand feet 99.99% Oxygen-Free Copper CMR Rated UL listed Network Cable-Cat6 from LTS, SKU LTAC6250BL-CMR, https://Itsecurityinc.com/, 17333 Freedom Way, City of Industry CA 91748
One (1) Cudy POE400 90 W Gigabit Ultra PoE++ Injector Adapter from Shenzhen Cudy Technology Co., Ltd. via Amazon.com, part number POE400, https://www.cudy.com/, Room A606, Gaoxingi Industrial Park, Liuxianyi Road, Baoan 67 District, Shenzhen, China
One (1) BV-Tech 3-Port PoE Extender from BV Security via Amazon.com, part number POE-RP101G, https://bvsecurity.com/, 1951 Landmeier Rd, Elk Grove Village, IL 60007
One (1) Gigabit Power-over-Ethernet Extender from UltraPoE via Amazon.com, part number PoE-2005-4P, https://ultrapoe.com/, 15322 Valley Blvd, City of Industry, CA 91746
One (1) Intellinet PoE++ Powered 5 Port Gigabit Ethernet Switch with PoE Passthrough from Intellinet Network Solutions via Amazon.com, part number 561808 IPS-05G-65 W, https://intellinetsolutions.com/, 550 Commerce Blvd, Oldsmar, FL 34677
One (1) PoE Texas 4 Port Inwall Gigabit PoE Extender from POE Texas via Amazon.com, part number GBT-4-IW, https://www.poetexas.com/, 11821 Buckner Road, Austin, TX 78726
One (1) Platinum Tools PoE++ Tester from Platinum Tools via Amazon.com, part number TPS200C, https://www.platinumtools.com/, 9730 Northcross Center Court Huntersville, NC 28078

A standard RJ-45 crimping tool with RJ-45 tips was also purchased. A standard monitor was already owned. A few other PoE switches and splitters were purchased, but not used in the final working example.

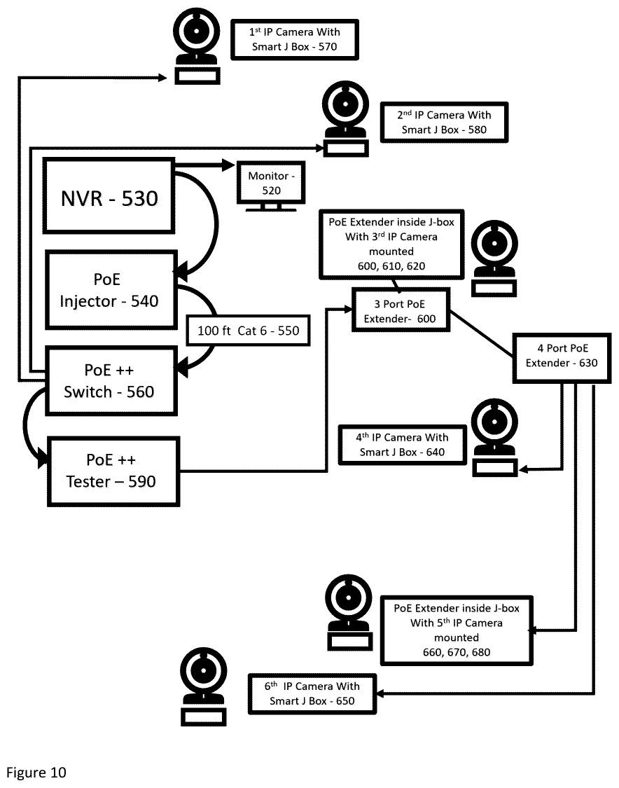

FIG. 10 is one aspect of the working product example electrically connected together. Item 520 is the monitor which is connected to Item 530, the 8-Channel NVR. A single port/channel of the NVR is connected to Item 540, the Cudy 90 W Gigabit Ultra PoE++ Injector Adapter, via a CAT 6 cable for power and bi-directional data. Item 550 is one hundred (100) feet of CAT 6 cable which is connected to the power out port on Item 540 and connects to the power in port on Item 560, the Intellinet PoE++ Ethernet Switch. Using one (1) of the PoE out ports on Item 560 it is connected via a CAT 6 cable directly to Item 570, the first IP camera mounted to the junction box (J-Box). Using another of the PoE out ports on Item 560 it is connected via a CAT 6 cable directly to Item 580, the second IP camera mounted to the J-Box. Using a third out port on Item 560, the CAT 6 cable is connected to Item 590, the PoE++ Tester, which in turn is connected via a CAT 6 cable to the power in port on Item 600, which is the BV-Tech 3-Port PoE Extender. Item 600 is inside Item 610, which is the J-Box for the third IP camera, which is Item 620. Item 620 is connected via a CAT 7 cable to Item 600 via an out port on Item 600. Item 620 is mounted to Item 610. Via a CAT 6 cable using another out port on Item 600 it is connected to Item 630, the PoE Texas 4 Port Inwall Gigabit PoE Extender. Via CAT 6 cables and three of its out ports Item 630 connects with Item 640, the fourth camera with J-Box in the network, Item 650, the fifth camera with J-Box in the network, and Item 660 the Gigabit Power-over-Ethernet Extender from Ultra PoE which is inside Item 670 the J-Box. Via a CAT 6 cable and one of its out ports Item 660 connects with Item 680 the sixth camera in the network. Item 680 is mounted to Item 670.

After connecting the six (6) IP cameras as described in the previous paragraph, the system was measured for powered consumption using Item 590 in a normal state and then a heightened state when the built-in motion detecting lights on the cameras were activated. Based on the measured results it was apparent that sufficient power was available such that additional cameras could have been added to the network, however only 2 additional IP cameras would have registered with Item 530 as Item 530 only has 8 ports and thus only 8 IP addresses can be assigned. Monitor 520 shows the of images of the 6 cameras received by Item 530 in the network. After registering each camera with NVR 530, the entire network did not show any noticeable latency. The tester 590 was then removed from the chain and Item 560 connected directly with Item 600. All 6 cameras received sufficient power and Item 530 registered the data provided by each camera.

After two days of testing, the six cameras were in installed in an office where the testing took place. Using a single port on the NVR a CAT 6 cable was connected to the in port on the POE Injector. The POE Injector was then connected to the PoE++ ethernet switch. From the switch 2 out ports were used, one to connect 3 cameras installed on the right side of the building and another to connect 3 cameras to the left side of the building. These 2 cables were run from the switch to additional switches/extenders that were resting on the ceiling tile. The right side and left side cameras are connected to these switches. Using the prior method of running “homeruns” the installation of the 6 cameras would have taken 2 technicians nearly a full day of work. Using the present inventive methodology, the 6 cameras were installed in approximately 3 hours by 1 technician. The system has been up and running consistently for several months.

The invention should only be limited by the attached claims as many variations are possible and envisioned.

1. A junction box containing:
(a) An inlet for receiving ethernet cable;
(b) a power over ethernet switch connected to the inlet;
(c) one or more outlets, connected to the power over ethernet switch, for communicating with an attached power over ethernet device;
(d) one or more outlets, connected to the power over ethernet switch, for providing power over ethernet communications to additional power over ethernet devices.

2. The junction box of claim 1, further comprising (e) a rechargeable battery, operably connected to the power over ethernet switch.

3. A method for connecting multiple power over ethernet devices in a security system, the method comprising:
(a) monitoring, on a network video recorder, events in the security system;
(b) connecting the network video recorder to a first power over ethernet switch;
(c) connecting the first power over ethernet switch to a first junction box, the first junction box having mounted thereon a first internet protocol camera, and having disposed within a second power over ethernet switch, the second power over ethernet switch connecting to the attached internet protocol camera;
(d) connecting the second power over ethernet switch to a second junction box, the second junction box containing a third power over ethernet switch.
